(19) United States
(12) Patent Application Publication
(10) Pub. No.: US 2005/0110743 A1
(43) Pub. Date: May 26, 2005

(54) Display device, method of driving display device and electronic equipment

(75) Inventor: Hideyuki Kawai, Fujimi-cho (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/958,397

(22) Filed: Oct. 6, 2004

(30) Foreign Application Priority Data
Oct. 21, 2003 (JP) 2003-360753
Jun. 30, 2004 (JP) 2004-193516

(51) Int. Cl. G09G 3/34

(52) U.S. Cl. 345/107

(57) ABSTRACT

Exemplary embodiments of the present invention provide a display device in which the time of an erasing action and the electric power consumption is reduced. Exemplary embodiments maintain reliability of TFT used as a switching element. A display device that has a data signal line that is provided in a plural number and a scanning signal line that intersects the data signal line and provided in a plural number, has a function of selecting the plurality of the scanning signal lines at the same time and a function of providing the same data signal to all the data signal lines at the same time. With this structure, the entire display region can be erased all at once.

### BACKGROUND OF THE INVENTION

1. Field of Invention

Exemplary embodiments of the present invention provide an electrophoretic display device that includes an electrophoretic dispersion liquid including a liquid dispersion medium and electrophoretic particles and an active matrix circuit, a method of driving the same and electronic equipment including the electrophoretic display device.

2. Description of Related Art

The related art includes an electrophoretic display device which has an electrophoretic dispersion liquid including a liquid dispersion medium and electrophoretic particles. When an electric field is applied to the electrophoretic dispersion liquid, a distribution of the electrophoretic particles is changed and an optical characteristic of the electrophoretic dispersion liquid changes. The electrophoretic display device as disclosed in Japanese Examined Patent Publication No. 50-15115, utilizes this optical characteristic change to display. Since such a electrophoretic display device does not require a backlight, it can contribute to reducing the cost and making the display device thinner. Further, the electrophoretic display device has a memory effect of the display in addition to a wide viewing angle and a high contrast.

An electrophoretic display device in which the electrophoretic dispersion liquid is encapsulated in a microcapsule is also proposed in related art document Japanese Unexamined Patent Publication No. 1-86116. It has an advantage that the electrophoretic dispersion liquid spilled during the manufacturing process of the display device can be reduced or prevented by encapsulating the electrophoretic dispersion liquid. In addition, there is another advantage that precipitation and aggregation of the electrophoretic particles can be reduced.

The related art includes, an electrophoretic display device, in which the above-mentioned electrophoretic display device and an active matrix device are combined. In the electrophoretic display device as disclosed in related art document Japanese Unexamined Patent Publication No. 2000-35775, an electric field is applied to the electrophoretic dispersion liquid by operating the active matrix device and a distribution of the electrophoretic particles is changed.

A structure of a related art electrophoretic display device is shown in FIG. 16. FIG. 16A is a schematic plan view of an active matrix device used in the electrophoretic display device. FIG. 16B is a schematic sectional view of a pixel region in the electrophoretic display device.

As shown in FIG. 16A, an active matrix device 1 has a data signal line 2 that is provided in a plural number and a scanning signal line 3 that intersects the data signal line and is provided in a plural number. The active matrix device 1 also has a data signal processing circuit 4 coupled to the data signal line 2 and a scanning signal processing circuit 5 coupled to the scanning signal line 3. The active matrix device 1 also has a switching element 6 such as a transistor and a pixel electrode 7 at an intersection of the data signal line 2 and the scanning signal line 3.

The data signal processing circuit 4 and the scanning signal processing circuit 5 include a serial input-parallel output shift register 43, in order to reduce the number of an input line. In other words, a pulse input 45 that is input from one end of the shift register is transformed into a parallel data by being shifted in sequence and synchronized with a clock, and it is output as a data signal or a scanning signal after it is transformed in some way by a circuit 44 other than a shift register (latch, level shifter and the like).

Here, the pixel electrode 7 is subjected to an electric action by providing signals into the data signal line 2 and the scanning signal line 3 from the data signal processing circuit 4 and the scanning signal processing circuit 5, and then controlling ON/OFF of the switching element 6.

For example, when a scanning data which selects only one of the scanning signal lines, is provided as some data signal is being provided to the data signal line, the switching element 6 that is coupled to the selected scanning signal line turns ON, and then the data signal line 2 and the pixel electrode 7 are electrically coupled substantially. In other words, a signal (voltage) supplied to the data signal line 2 at the time will be supplied to the pixel electrode 7 through the switching element 6 that is ON. In contrast, a switching element that is coupled to the unselect scanning signal line remains OFF, and the data signal line and the pixel electrode are substantially electrically uncoupled.

As described the above, since the active matrix device can selectively turn ON/OFF the transistor that is coupled to the intended scanning signal line, a cross talk problem hardly occurs and it is possible to speed up the circuit operation.

In the active matrix device, there are two ways of controlling the data signal line and the scanning signal line. They are a point-sequential control and a line-sequential control.

The point-sequential control is a way of supplying the scanning signal in which only one of the scanning signal lines is selected as a data signal is provided to one of the data signal lines, and the data signal is always provided to the only one pixel electrode (at the intersection of the data signal line to which the data signal is provided and the selected scanning signal line). In contrast, the line-sequential control is a way of supplying the scanning signal in which only one of the scanning signal lines is selected when all the data for all the data signal lines are ready through the shift register, and the data signals are provided to all the pixel electrodes that are coupled to the selected scanning signal line.

As shown in a sectional view of FIG. 16B, in each pixel, the pixel electrode 7 and a common electrode 8 are provided so as to oppose each other with a predetermined space therebetween (normally from several μm to several tens of μm). An electrophoretic dispersion liquid 10 that includes a liquid dispersion medium 11 and an electrophoretic particle 12 is enclosed in the space. Here, for the sake of simplicity, the data signal line and the scanning signal line are omitted in FIG. 16B.

With such structure, when the above-described operation is conducted and an indicated data signal (voltage) is supplied to the pixel electrode 7 as maintaining the common electrode 8 at a predetermined voltage, the electrophoretic particle 12 electrophoretically moves according to a voltage potential difference (electric field) between the common electrode and the pixel electrode and the distribution of the electrophoretic particles is changed.

On such principal, an intended picture can be obtained by controlling the data signal (voltage) that is provided to each pixel.

Here, generally, at least about 10 V of the voltage potential difference is required to induce the change of the electrophoretic particles' distribution. In addition, to give the particle traction and repulsive force, a structure that can apply bipolar voltage (positive and negative voltage) is needed. In other words, for example, when electric potential of the common electrode is set to be 0 V, a voltage of +10 V and −10 V should be provided to the pixel electrode. A breakdown-voltage of the switch element should be no less than 20 V.

However, in the related art, a thin film transistor (hereinafter “TFT”), which is generally used as the switching element of the active matrix device, has a such character that the higher voltage is applied to the TFT, the larger its deteriorating rate becomes. Especially when the applied voltage is more than 20 V, it is difficult to secure the reliability of the TFT.

To address or solve the above-mentioned and/or other problems, related art document Japanese Unexamined Patent Publication No. 2002-149115 discloses erasing the displayed picture up to then throughout the display region at the time of changing the picture and then write a new picture. Explaining this with a concrete description, for example, all the pixel electrodes are set to be the same voltage (for example, 0 V) and 10 V is applied to the common electrode. When the displayed picture up to then is erased throughout the display region and then, when a new picture is written, the common electrode is set to be 0 V and 10 V is applied to only the pixel electrodes of the intended pixels that should be written (desired pixels where to move the particles). As just described, the voltage applied to the switching element is reduced by applying different voltage to the common electrodes at the time of erasing throughout the display region and at the time of writing a new picture.

### SUMMARY OF THE INVENTION

However, there are the following problems in the above-described related art.

When the displayed picture up to then is erased throughout the display region, in other words, when the same voltage is applied to the all the pixel electrodes, the voltage is sequentially applied to each pixel electrode one by one in the case of the point-sequential control. Also, in the case of the line-sequential control, the procedure, in which the same data is sent to all the data signal lines through the shift register and then only one of the scanning signal lines is selected when all the data signal lines are ready, has to be repeated as many times as the number of the scanning signal lines.

In other words, according to the related art, each circuit such as the shift register, has to be operated at the time of erasing throughout the display region as well as the time of writing a new picture. For this reason, there are problems that the erasing action takes time and electric power consumption increases.

Exemplary embodiments of the present invention have been developed in consideration of the above discussed and/or other problems. Exemplary embodiments provide a display device in which the time of the erasing action and the electric power consumption are reduced as well as maintaining the reliability of the TFT used as the switching element. Exemplary embodiments of the present invention also provide a method of driving the display device and electronic equipment.

In order to address or solve the above-mentioned and/or other related art problems, a display device of exemplary embodiments of the present invention have a structure of erasing the entire display region all at once.

More particularly, in the display device, a scanning signal processing circuit selects all the scanning signal lines at the same time, and a data signal processing circuit supplies the same data signal to all the data signal lines at the same time as well as supplying specific data signal to each corresponding data signal line.

This makes it possible to erase the entire display region all at once and this can dramatically reduce the time of the erasing action.

Moreover, in the display device, an electrophoretic dispersion liquid including a liquid dispersion medium and electrophoretic particles may be used as a display material.

With the above-mentioned structure, the display device which is low cost, thin and having a wide viewing angle, a high contrast and a memory effect of the display can be provided.

Furthermore, in the display device, the electrophoretic dispersion liquid may be encapsulated in a microcapsule. The electrophoretic dispersion liquid's spill during the manufacturing process of the display device can be reduced or prevented and precipitation and aggregation of the electrophoretic particles can be reduced by encapsulating the electrophoretic dispersion liquid.

Moreover, in the display device, the scanning signal processing circuit may further include a scanning line selection circuit that selects a specific scanning signal line from a plurality of the scanning lines and at least one scanning line control signal line, and also selects all the scanning lines at the same time by inputting a predetermined signal to the scanning line control signal line irrespective of a signal from the scanning line selection circuit.

Also, in the display device, the data signal processing circuit may further include a data line selection circuit to supply a respective specific data signal to the each data signal line and at least one data line control signal line, and also supplies the same data signal to all the data lines at the same time by inputting a predetermined signal to the data line control signal line irrespective of a data signal from the data line selection circuit.

With the above-described structure, operation of the scanning line selection circuit and the data line selection circuit can be halted during the entire display region erasing action, and only the scanning line control signal line and the data line control signal line is operated. This makes it possible to reduce the electric power consumption.

A driving method of a display device of exemplary embodiments of the present invention is a driving method for the display device that includes an electrophoretic dispersion liquid including a liquid dispersion medium and electrophoretic particles, a data signal line provided in a plural number, a scanning signal line intersecting the data signal line and provided in a plural number. The display device also includes a data signal processing circuit providing a data signal to the plurality of the data signal lines and having a specific data signal sending function of supplying specific data signal to each corresponding data signal line and a all data signal sending function of supplying the same data signal to all the data signal lines at the same time. Further, scanning signal processing circuit provides a scanning signal to the plurality of the scanning signal lines and has a specific selecting function of selecting a specific scanning line from the plurality of the scanning signal lines and a all selecting function of selecting all the scanning signal lines at the same time, and in which the optical characteristic of the display material is changed by controlling the data signal and the scanning signal. The driving method of the display device of exemplary embodiments of the present invention include a step of erasing an old picture throughout the entire display region by setting off the all data signal sending function to send the same erasing data signal to all the data signal lines at the same time and setting off the all selecting function when a picture of the display device is rewritten and a step of writing a new picture by setting off the specific data signal sending function and the specific selecting function after erasing the old picture.

An electronic equipment of exemplary embodiments of the present invention include any one of the above-described display devices. With the above-described display device, electronic equipment in which the time of an erasing action and the electric power consumption are reduced can be provided.

### BRIEF DESCRIPTION OF THE DRAWINGS

FIG. 1A is a schematic plan view of a display device of a first exemplary embodiment according to the present invention;

FIG. 1B is a timing chart of each signal line in the first exemplary embodiment;

FIG. 2 is a schematic sectional view of a pixel member in a display device according to the present invention in a second exemplary embodiment;

FIG. 3 is a schematic sectional view of a pixel member in a display device according to the present invention in a third exemplary embodiment;

FIG. 4 is a schematic sectional view of a pixel member in a display device according to the present invention in a forth exemplary embodiment;

FIG. 5A is a schematic sectional view of a pixel member in a display device according to the present invention in a fifth embodiment;

FIG. 5B is a schematic sectional view of a modification of the pixel member in the display device according to the present invention in the fifth exemplary embodiment;

FIG. 6A is a schematic showing a structure of a scanning signal processing circuit in a display device of a sixth exemplary embodiment according to the present invention;

FIG. 6B is a timing chart of each signal line in the sixth exemplary embodiment;

FIG. 7 is a schematic showing a structure of a scanning signal processing circuit in a display device of a seventh exemplary embodiment according to the present invention;

FIG. 8A is a schematic showing a structure of a data signal processing circuit in a display device of an eighth exemplary embodiment according to the present invention;

FIG. 8B is a timing chart of each signal line in the eighth exemplary embodiment;

FIG. 9 is a schematic showing a structure of a data signal processing circuit in a display device of a ninth exemplary embodiment according to the present invention;

FIG. 10 is a schematic perspective view showing an exemplary embodiment of which electronic equipment of the present invention is applied to a cellular phone;

FIG. 11 is a schematic perspective view showing an exemplary embodiment of which the electronic equipment of the present invention is applied to a digital still camera;

FIG. 12 is a schematic perspective view showing an exemplary embodiment of which the electronic equipment of the present invention is applied to an electronic book;

FIG. 13 is a schematic perspective view showing an exemplary embodiment of which the electronic equipment of the present invention is applied to an electronic paper;

FIG. 14 is a schematic perspective view showing an exemplary embodiment of which the electronic equipment of the present invention is applied to an electronic notebook;

FIG. 15A is a schematic sectional view of a display to which the electronic equipment of exemplary embodiments of the present invention is applied;

FIG. 15B is a schematic plan view of the display to which the electronic equipment of exemplary embodiments of the present invention is applied;

FIG. 16A is a schematic plan view of a display device used in an electrophoretic display device of related art; and

FIG. 16B is a schematic sectional view of a pixel region in the electrophoretic display device.

### DETAILED DESCRIPTION OF PREFERRED EMBODIMENTS

Exemplary embodiments of the present invention will now be described in detail with reference to the accompanying drawings.

### Exemplary Embodiment 1

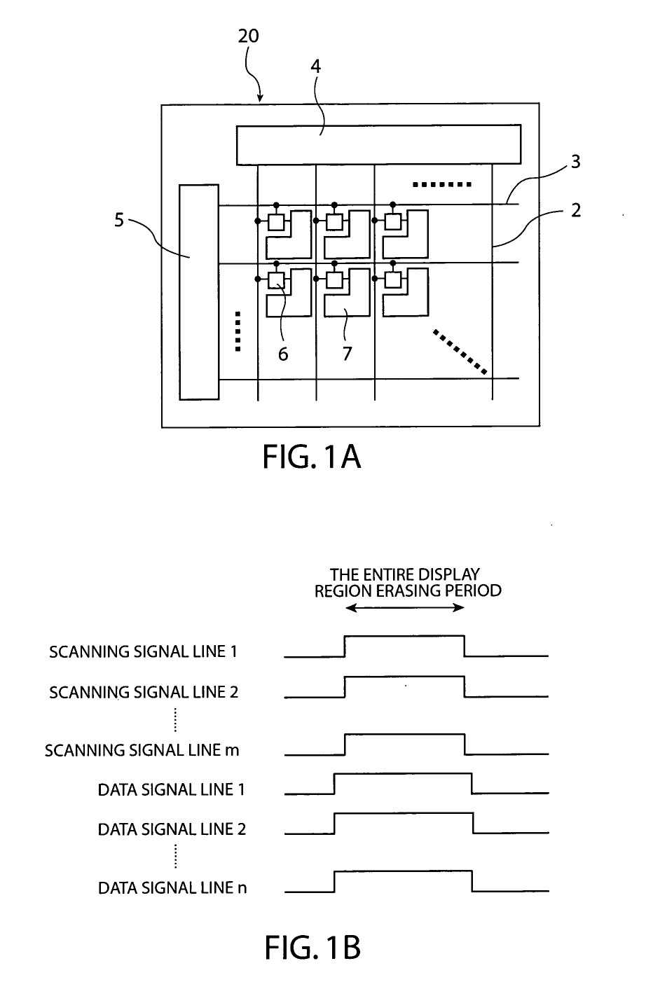

FIG. 1 shows a first exemplary embodiment of a display device according to the present invention. FIG. 1A is a schematic plan view of the display device, and FIG. 1B is a timing chart of each signal line.

As shown in FIG. 1A, a display device 20 according to exemplary embodiments of the present invention include a display material (not shown in the figure) whose optical characteristic changes in response to electric stimulus, the data signal line 2 that is provided in a plural number and the scanning signal line 3 that intersects the data signal line and is provided in a plural number. The display device 20 also has the data signal processing circuit 4 providing a data signal to the data signal lines and the scanning signal processing circuit 5 providing a scanning signal to the scanning signal lines. An intended signal (voltage) is applied to the intended pixel electrode 7 by appropriately controlling the data signal and the scanning signal in the above-described way, and the optical characteristic of the display material is changed so as to display an intended picture.

Here, the scanning signal processing circuit 5 selects all the scanning signal lines at the same time. Also, the data signal processing circuit 4 supplies all the data signal lines at the same time in addition to supplying each specific data signal to each corresponding data signal line.

When a picture of the display is rewritten in the display device 20, as described above, once the entire picture is erased throughout the display region, and then a new picture is written. Wave profiles of the data signal line and the scanning signal line at the time of such erasing action are shown in FIG. 1B.

As shown in FIG. 1B, when the erasing action throughout the display region is conducted, the data signal processing circuit 4 sets off the above-described function and provides the same data signal to all the data signal lines at the same time. On the other hand, the scanning signal processing circuit 5 sets off the above-described function and selects all the scanning signal lines at the same time. These actions provide the same signal (voltage) to all the pixel electrodes all at once. At this time, the entire display region can be erased at one time by applying an appropriate voltage to the common electrode.

### Exemplary Embodiment 2

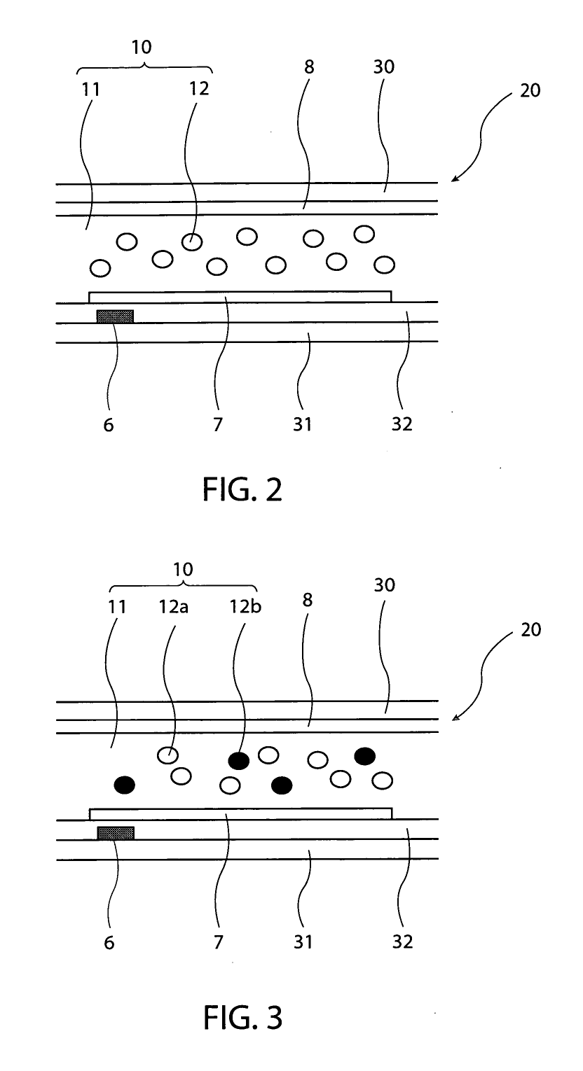

FIG. 2 is a schematic sectional view of a pixel member in a display device according to the present invention in a second exemplary embodiment.

The display device includes a first substrate 30, a common electrode 8 formed on the first substrate, a second substrate 31, the pixel electrode 7 provided on the common electrode side of the second substrate and the switching element 6 that turns ON/OFF a signal provided to the pixel electrode. The pixel electrode 7 and the common electrode 8 are provided so as to oppose each other with a predetermined space formed by a member (not shown) such as a spacer and a wall therebetween. In addition, the electrophoretic dispersion liquid 10 that includes the liquid dispersion medium 11 and the electrophoretic particle 12 is enclosed in the space between the pixel electrode 7 and the common electrode 8. Here, the data signal line and the scanning signal line is omitted in the figure.

Operation of the display device will be described below. In the following description, it is assumed that the electrophoretic particle 12 is positively charged. Even if the electrophoretic particle 12 is negatively charged, the same principal can be applied, except for turning the direction of applying the voltage upside down.

First, in the process of the entire display region erasing action, the data signal processing circuit 4 (not shown in the figure) sets off the providing the same data signal to all the data signal lines at the same time, and provides 0 V to the all the data signal lines. On the other hand, the scanning signal processing circuit 5 (not shown in the figure) sets off the selecting all the scanning signal lines at the same time. By these actions, 0 V is provided to all the pixel electrodes. At this time, when the positive voltage (for example +10 V) is applied to the common electrode 8, electric field is generated from the common electrode to the pixel electrode. And the positively charged electrophoretic particle moves electrophoretically toward the pixel electrode along the electric field. Consequently, the electrophoretic particles move toward the pixel electrodes throughout the display region (erasing the entire display region).

Subsequently, the common electrode 8 is set to be 0 V. And, with the above-mentioned normal active-matrix operation, in other words, the line-sequential control or the point-sequential control, a positive voltage (for example +10 V) is sequentially provided to the pixel electrode that is intended to be written the picture (intended to move the particle) and 0 V is sequentially provided to the pixel electrode that is intended not to be written the picture (intended not to move the particle). At this time, electric field is generated from the pixel electrode to the common electrode in the pixel electrode provided with the positive voltage, and the positively charged electrophoretic particle moves electrophoretically toward the common electrode along the electric field. On the other hand, in the pixel electrode that is provided with 0 V, voltage potential difference (electric field) is not generated and the electrophoretic particles do not move electrophoretically. In this way, the picture is written by moving the particles in the only intended pixels.

Here, the following can be used as the liquid dispersion medium 11, though it is not limited particularly to, for example, water, methanol, ethanol, isopropanol, butanol, octanol, methyl cellosolve, and other alcohol-based solvents, ethyl acetate, butyl acetate, and other various esters, acetone, methylethylketone, methylisobutylketone, and other ketones, pentane, hexane, octane, and other aliphatic hydrocarbons, cyclohexane, methylcyclohexane, and other alicyclic hydrocarbons can be used. Also, benzene, toluene, xylene, hexylbenzene, hebutylbenzene, octylbenzene, nonylbenzene, decylbenzene, undecylbenzene, dodecylbenzene, tridecylbenzene, tetradecylbenzen, and other aromatic hydrocarbons having long-chain alkyl, methylene chloride, chloroform, carbon tetrachloride, 1,2-cycloethane, and other halogenated hydrocarbons, carboxylates, and other various oils and the like alone or in mixtures plus a surfactant etc., can be used as the liquid dispersion medium 11.

Furthermore, the liquid dispersion medium 11 may be substantially transparent or may be opaque. Also, if necessary, it may be colored with desired color. As colorant to color the liquid dispersion medium 11, though it is not limited particularly to, for example, anthraquinone series, azo series, diazo series, amine series, diamine series, and other chemical compound dye, cochineal dye, carminic acid dye, and other natural dye, azo series, polyazo series, anthraquinone series, quinacrilidone series, isoindolene series, isoindolenone series, phthalocyanine series, perylene series, and other organic pigment, carbon black, silica, chromic oxide, iron oxide, titanium oxide, zinc sulphide and other inorganic pigment alone or in mixtures, can be used.

The electrophoretic particle 12 is an organic or inorganic particle, or a compound particle able to electrophoretically move in the dispersion medium due to the potential difference. As the electrophoretic particle 12, though it is not limited particularly to, for example, aniline black, carbon black, or other black pigments, titanium dioxide, zinc oxide, antimony trioxide, and other white pigments, monoazo, dis-azo, polyazo, and other azo-based pigments, isoindolenone, yellow lead oxide, yellow iron oxide, cadmium yellow, titanium yellow, antimony, and other yellow pigments, monoazo, dis-azo, polyazo, and other azo-based pigments, quinacrilidone red, chrome vermillion, and other red pigments, phthalocyanine blue, indanthrene blue, anthraquinone-based dyes, prussian blue, ultramarine blue, cobalt blue, and other blue pigments, phthalocyanine green and other green pigments alone or in combinations of two or more types, can be used.

In addition, if necessary, the following substance may be added to the above-mentioned colorant: electrolyte, surfactant, metal soap, resin, rubber, oil, varnish, a charge controlling agent that consists of particles of a compound and the like, titanium-based coupling agent, aluminum-based coupling agent, silane-based coupling agent, and other coupling agent, polyethylene oxide, polystyrene, acrylic, and other macromolecule itself or other polymer dispersant that consists of block polymer, lubricant, stabilizer, etc.

### Exemplary Embodiment 3

FIG. 3 is a schematic sectional view of a pixel member in a display device according to the present invention in a third exemplary embodiment.

In this exemplary embodiment, the electrophoretic particles include two different kind particles 12a and 12b. Other components of the display device are the same as those in the above-described second exemplary embodiment.

Operation of the display device according to this exemplary embodiment will be described below. In the following description, it is assumed that the electrophoretic particle 12a is white and positively charged, and the electrophoretic particle 12b is black and negatively charged. The particle color and the particle polarity of electrostatic charge are not particularly limited. For example, even if the polarities of these particles are the other way around, the same principal can be applied, except for turning the direction of applying the voltage upside down.

First, in the process of the entire display region erasing action, the data signal processing circuit sets off the providing the same data signal to all the data signal lines at the same time, and provides 0 V to the all the data signal lines. On the other hand, the scanning signal processing circuit 5 sets off the selecting all the scanning signal lines at the same time. By these actions, 0 V is provided to all the pixel electrodes. At this time, when the positive voltage (for example +10 V) is applied to the common electrode 8, electric field is generated from the common electrode to the pixel electrode. And then, the positively charged electrophoretic particle 12a moves electrophoretically toward the pixel electrode along the electric field, and the negatively charged electrophoretic particle 12b moves electrophoretically toward the common electrode. Consequently, the electrophoretic particles 12a move toward the pixel electrodes and the electrophoretic particles 12b move toward the common electrode throughout the display region. At this time, the entire display region looks the color of the electrophoretic particle 12b or black when it is observed from the common electrode side. Contrary, the entire display region looks the color of the electrophoretic particle 12a or white when it is observed from the pixel electrode side.

Subsequently, the common electrode 8 is set to be 0 V. And, with the above-mentioned normal active-matrix operation, in other words, the line-sequential control or the point-sequential control, a positive voltage (for example +10 V) is sequentially provided to the pixel electrode that is intended to be written to the picture (intended to move the particle) and 0 V is sequentially provided to the pixel electrode that is intended not to be written to the picture (intended not to move the particle). At this time, an electric field is generated from the pixel electrode to the common electrode in the pixel electrode provided with the positive voltage, and the positively charged electrophoretic particle 12a moves electrophoretically toward the common electrode along the electric field and the negatively charged electrophoretic particle 12b moves electrophoretically toward the pixel electrode. On the other hand, in the pixel electrode that is provided with 0 V, voltage potential differences (electric field) is not generated and both electrophoretic particles 12a and 12b do not move electrophoretically. At this time, a white picture against a black background will be seen when it is observed from the common electrode side. Contrary, a black picture against a white background will be seen when it is observed from the pixel electrode side.

In this way, the picture is written by moving the particles in the only intended pixels.

Furthermore, a mixed color of that of the electrophoretic particle 12a and that of the electrophoretic particle 12B, in other words, a color between that of the electrophoretic particle 12a and that of the electrophoretic particle 12b can be displayed by adjusting magnitude of the signal (voltage) applied to the pixel electrode at the time of the above-described picture writing action and a time length of the signal, and controlling the distribution of the particles.

For the liquid dispersion medium 11 and the electrophoretic particle 12 in this exemplary embodiment, the same material may be used as one mentioned in the second exemplary embodiment.

Also, the liquid dispersion medium 11 in this exemplary embodiment may be substantially transparent or may be opaque. Also, if necessary, it may be colored with desired color.

In the description above, though the electrophoretic particle consists of two different kinds of particles, the electrophoretic particle may consist of more than three different kinds of particles. In such case, multicolor display is possible by adjusting magnitude of the signal (voltage) applied to the pixel electrode and controlling mutual distribution of the more than three different kinds of particles.

### Exemplary Embodiment 4

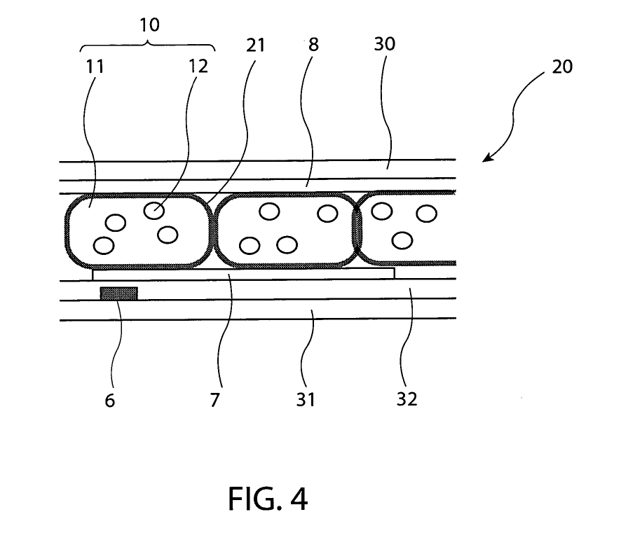

FIG. 4 is a schematic sectional view of a pixel member in a display device according to the present invention in a forth exemplary embodiment.

In this exemplary embodiment, as shown in the figure, the electrophoretic dispersion liquid 10 is encapsulated in a microcapsule 21 and provided between the pixel electrode 7 and the common electrode 8. Other components of the display device are the same as those in the above-described second exemplary embodiment.

The electrophoretic particle 12 included in the electrophoretic dispersion liquid 10 may consist of one type particle as described in the first exemplary embodiment, or more than two different kinds of particles as described in the second exemplary embodiment.

In this way, spilling of the electrophoretic dispersion liquid during the manufacturing process of the display device can be reduced or prevented by encapsulating the electrophoretic dispersion liquid. In addition, precipitation and aggregation of the electrophoretic particles can be reduced. Furthermore, such as a spacer and a wall member for providing the pixel electrode 7 and the common electrode 8 so as to oppose each other with a predetermined space, are not necessary. It leads to cost cutting and it makes it possible to provide the electrophoretic dispersion liquid between substrates that have flexibility. This means that application to electric paper is a possibility.

As a wall-film material of such microcapsule 21, for example, gelatin, polyurethane resin, polyurea resin, urea resin, melamine resin, acrylic resin, polyester resin, and other resin material. Such material alone or in combinations of two or more types can be used.

As a method of forming the microcapsule 21, for example, interfacial polymerization method, in-situ polymerization method, phase separation method, interfacial precipitation method, spray-drying method, and other micro-capsulation method can be used.

It is preferable that microcapsules used for the display device according to exemplary embodiments of the present invention have similar size. With the similar-sized microcapsules, better display capability can be brought to the display device 20. To equalize the size of the microcapsules 21, for example, percolation, screening, segregation using difference in specific gravity and the like, can be employed.

The size of the microcapsule 21 (average particle diameter) is not particularly limited, however, about 10-150 μm is desirable, more preferably, 30-100 μm.

In addition, it is preferred that the microcapsule is provided between the pixel electrode and the common electrode so as to contact both. Also, it is preferred that the microcapsule is formed to have a flat surface along at least either the pixel electrode or the common electrode. With such structure, better display capability can be brought to the display device 20.

Furthermore, in the display device according to this exemplary embodiment, a binder material may be provided between the pixel electrode 7 and the common electrode 8 and around the microcapsule 21. In other words, in this exemplary embodiment, the binder material can be a component of the display device. Each microcapsule will be solidly fixed by providing the binder material. Moreover, it will enhance the attachment of the microcapsule and the pixel electrode or the common electrode as well as protecting the microcapsule from mechanical shock.

As such binder material, it is not particularly limited as long as it has a good affinity and adhesiveness with the wall-film material of the microcapsule and has an insulating ability. For example, polyethylene, chlorinated polyethylene, ethylene-vinyl acetate copolymer, ethylene-ethyl acrylate copolymer, polypropylene, ABS resin, methyl methacrylate resin, vinyl chloride resin, vinyl chloride-vinyl acetate copolymer, vinyl chloride-vinylidene chloride copolymer, vinyl chloride-acrylic acid ester copolymer, vinyl chloride-methacrylic acid copolymer, vinyl chloride-acrylonitrile copolymer, ethylene-vinyl alcohol-vinyl chloride copolymer, propylene-vinyl chloride copolymer, vinylidene chloride resin, vinyl acetate resin, polyvinyl alcohol, polyvinyl formal, cellulose-based resin, or other thermoplastic resin, can be used. Also, polyamide-based resin, polyacetal, polycarbonate, polyethylene terephthalate, polybutylene terephthalate, polyphenylene oxide, polysulfone, polyamide imide, polyamino bismaleimide, polyether sulfone, polyphenylene sulfone, polyarylate, grafted polyphenylene ether, polyether ether ketone, polyether imide, and other heat resistant, mechanically strong polymers, polyethylene tetrafluoride, polyethylene propylene fluoride, ethylene tetrafluoride-perfluoroalkoxyethylene copolymer, ethylene-ethylene tetrafluoride copolymer, polyvinylidene fluoride, polyethylene trifluorochloride, fluororubber, or other fluororesins, silicone resins, silicone rubber, and other silicone resins, can be used as the binder material. As other binder material, methacrylic acid-styrene copolymer, polybutylene, methyl methacrylate-butadiene-styrene copolymer, etc. may be used. Also, such material alone or in combinations of two or more types can be used.

Furthermore, it is preferred that a dielectric rate of the binder material and a dielectric rate of the liquid dispersion medium 11 is approximately the same. Consequently, a dielectric regulator, such as 1,2-butanediol, 1,4-butanediol, and other alcholoes, ketones and carboxylates, is preferably added to the binder material.

A composite film of the microcapsule and the binder material can be formed the following way. For example, the microcapsules, if necessary, and the above-mentioned dielectric regulator are mixed into the binder material, then a resin composition (emulsion or organic solvent solution) is obtained. And the resin composition is provided on the pixel electrode or a transparent electrode by, for example, roll coater method, roll laminator method, screen printing method, spray method, ink-jet method and other application method. As a consequence, the composite film is obtained.

### Exemplary Embodiment 5

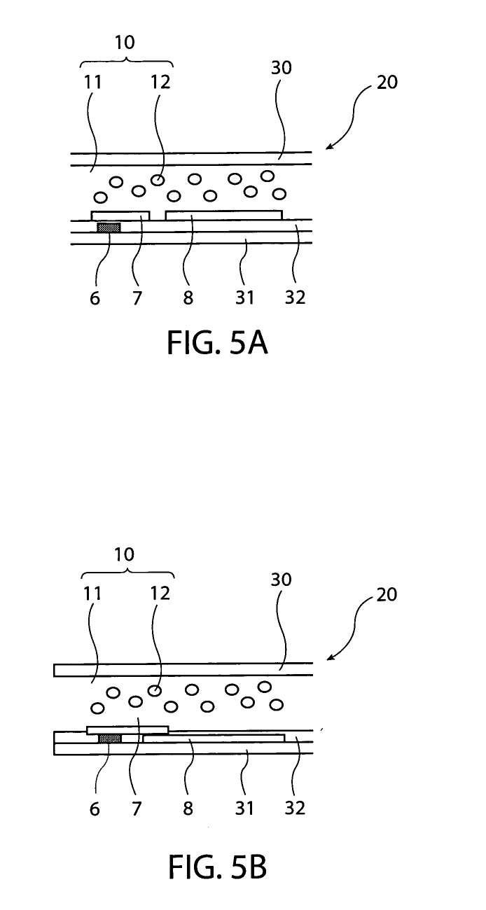

FIG. 5A is a schematic sectional view of a pixel member in a display device according to the present invention in a fifth exemplary embodiment.

The display device includes the first substrate 30, the second substrate 31 provided so as to oppose the first substrate, the common electrode 8 and the pixel electrode 7 formed on the second substrate and the switching element 6 that turns ON/OFF a signal provided to the pixel electrode. In addition, the electrophoretic dispersion liquid 10 that includes the liquid dispersion medium 11 and the electrophoretic particle 12 is enclosed in the space between the first substrate 30 and the second substrate 31. Here, the data signal line and the scanning signal line is omitted in the figure.

In the display device of this exemplary embodiment, the electrophoretic particle 12 moves in a horizontal direction to the substrate according to the electric field applied between the common electrode 8 and the pixel electrode 7. This means that difference in an in-plane distribution of the particles between when the particles deposit on the common electrode and when the particles deposit on the pixel electrode, is used to display a picture.

Operation of the display device will be described below. In the following description, it is assumed that the electrophoretic particle 12 is positively charged. Even if the electrophoretic particle 12 is negatively charged, the same principal can be applied, except for turning the direction of applying the voltage upside down. Also, moving the particles to the pixel electrode side is tentatively called “erasing” and moving the particles to the common electrode is tentatively called “writing”. However, this is just for the sake of convenience and they can be inverted.

First, in the process of the entire display region erasing action, the data signal processing circuit 4 (not shown in the figure) sets off the providing the same data signal to all the data signal lines at the same time, and provides 0 V to the all the data signal lines. On the other hand, the scanning signal processing circuit 5 (not shown in the figure) sets off the selecting all the scanning signal lines at the same time. By these actions, 0 V is provided to all the pixel electrodes 7. At this time, when the positive voltage (for example +10 V) is applied to the common electrode 8a, horizontal electric field is generated from the common electrode to the pixel electrode. And the positively charged electrophoretic particle moves electrophoretically toward the pixel electrode along the electric field. Consequently, the electrophoretic particles move toward the pixel electrodes throughout the display region (erasing the entire display region).

Subsequently, the common electrode 8 is set to be 0 V. And, with the above-mentioned normal active-matrix operation, in other words, the line-sequential control or the point-sequential control, a positive voltage (for example +10 V) is sequentially provided to the pixel electrode that is intended to be written the picture (intended to move the particle) and 0 V is sequentially provided to the pixel electrode that is intended not to be written the picture (intended not to move the particle). At this time, electric field is generated from the pixel electrode to the common electrode in the pixel electrode provided with the positive voltage, and the positively charged electrophoretic particle moves electrophoretically toward the common electrode along the electric field. On the other hand, in the pixel electrode that is provided with 0 V, voltage potential difference (electric field) is not generated and the electrophoretic particle dose not move electrophoretically. In this way, the picture is written by moving the particles in the only intended pixels.

Furthermore, a mixed color of that of the electrophoretic particle 12a and that of the electrophoretic particle 12b, in other words, a color between that of the electrophoretic particle 12a and that of the electrophoretic particle 12b, can be displayed by adjusting magnitude of the signal (voltage) applied to the pixel electrode at the time of the above-described picture writing action and a time length of the signal, and controlling the distribution of the particles.

For the liquid dispersion medium 11 and the electrophoretic particle 12 in this exemplary embodiment, the same material may be used as one mentioned in the second exemplary embodiment.

In FIG. 5A, the common electrode 8 is shown larger than the pixel electrode 7. However, this is just for the sake of convenience and the size is decided depending on the intended image property. Therefore, there is no problem if the pixel electrode 7 is larger than the common electrode 8 or they are the same size.

Furthermore, it is not necessary to arrange the common electrode 8 and the pixel electrode 7 in the same plane. For example, as shown in FIG. 5B, the pixel electrode 7 may overlap the common electrode 8.

### Exemplary Embodiment 6

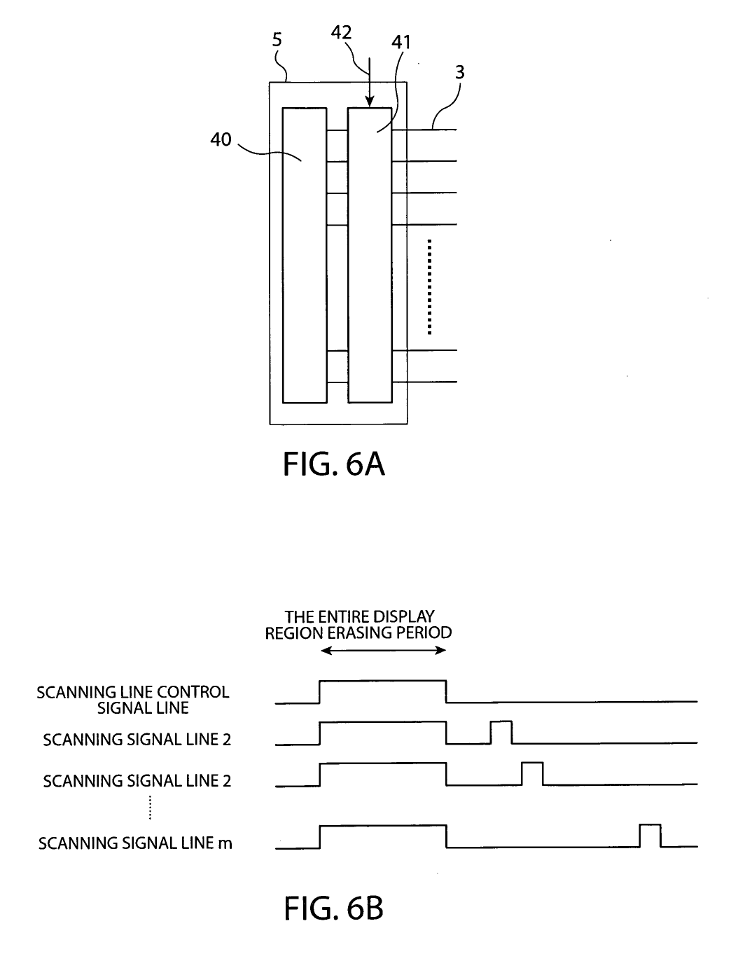

FIGS. 6A-B shows a sixth exemplary embodiment of a display device according to the present invention.

As shown in the figures, in the display device according to this exemplary embodiment, the scanning signal processing circuit 5 includes a scanning line selection circuit 40, at least one scanning line control signal line 42 and a scanning line control circuit 41.

Here, the scanning line selection circuit 40 selects a specific scanning signal line from a plurality of the scanning lines 3. The scanning line control circuit 41 selects all the scanning lines at the same time by inputting a predetermined signal to the scanning line control signal line 42, irrespective of a signal from the scanning line selection circuit 40.

Since the display device according to this exemplary embodiment has such structure, as shown in FIG. 6B, all the scanning lines can be selected at the same time by inputting the predetermined signal (in the figure, Hi signal) to the scanning line control signal line 42 when the entire display region is erased irrespective of the signal from the scanning line selection circuit 40. In this way, all the switching elements turn ON and the display can be erased all at once throughout the display region.

Furthermore, since the above-described action which is selecting all the scanning signal lines at the same time, is performed irrespective of the signal from the scanning line selection circuit 40, operation of the scanning line selection circuit 40 can be halted during the entire display region erasing action. This makes it possible to reduce the electric power consumption.

Next, when a new picture is written, only the switching element coupled to a specific scanning signal line can be turned ON by selecting the specific scanning signal line with the scanning line selection circuit 40 without inputting a predetermined signal to the scanning line control signal line 42.

### Exemplary Embodiment 7

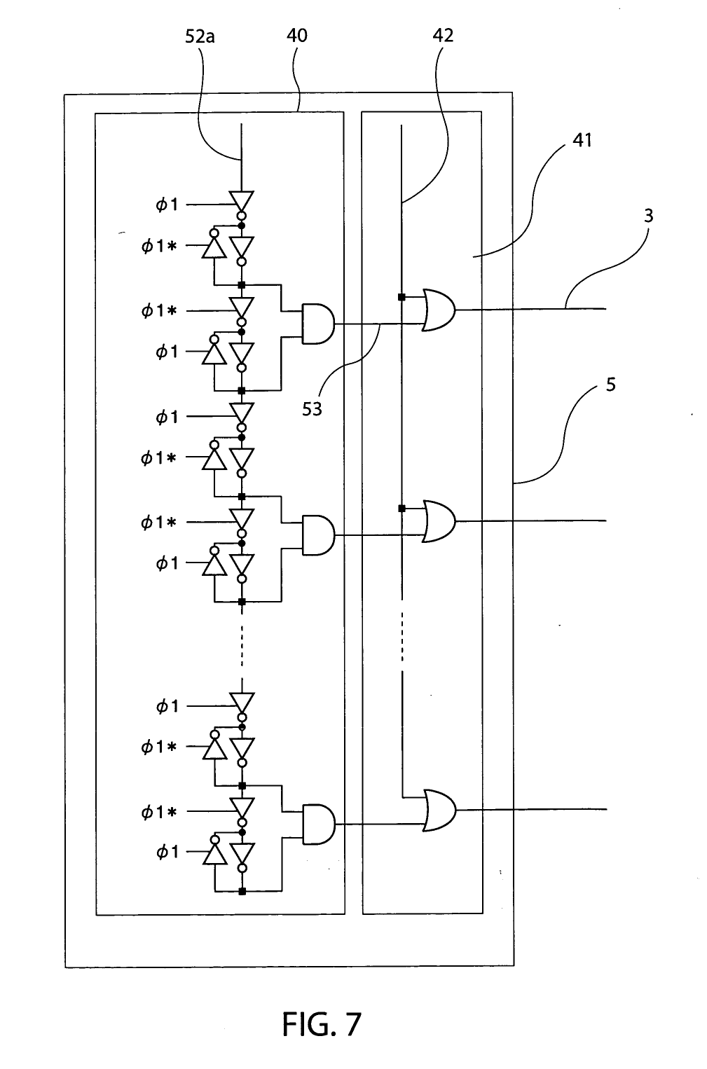

FIG. 7 is a schematic showing a seventh exemplary embodiment of a display device according to the present invention.

As shown in the figure, in the display device according to this exemplary embodiment, the scanning signal processing circuit 5 includes the scanning line selection circuit 40, a scanning pulse input 52a, the scanning line control signal line 42 and the scanning line control circuit 41. The scanning line selection circuit 40 is formed from a clocked-inverter type shift register whose input is the scanning pulse input 52a. A pulse signal input from the scanning pulse input 52a is sequentially sent synchronized with a clock Φ1 and a clock Φ1* (Φ1 and Φ1* are mutually reversed phase). The sent pulse signal becomes a scanning selection signal 53 for selecting a specific scanning signal line from a plurality of the scanning lines. The scanning line control circuit 41 consists of a plurality of OR circuits having the scanning line control signal line 42 as one input, and the scanning selection signal 53 as the other input and the scanning signal line as an output.

At the time of the entire display region erasing, all the scanning signal lines become logical “Hi” at the same time by inputting the logical Hi to the scanning line control signal line 42 irrespective of the scanning selection signal 53 from the scanning line selection circuit 40. In this way, all the switching elements turn ON and the display can be erased all at once throughout the display region.

On the other hand, when a new picture is written, logical “Lo” is input to the scanning line control signal line 42. Then, a specific scanning signal line can be selected because the scanning selection signal 53 is provided to the scanning signal line without change.

### Exemplary Embodiment 8

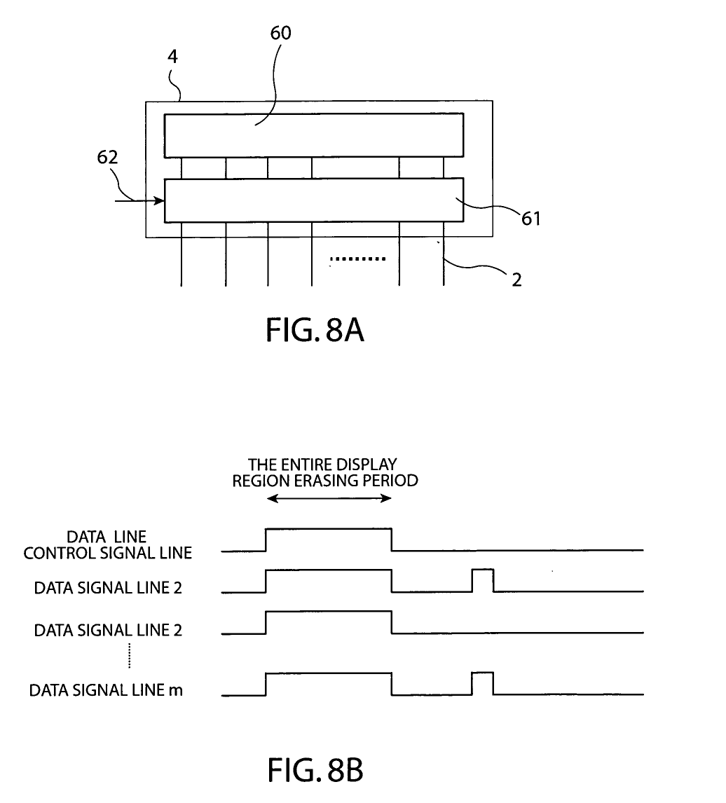

FIGS. 8A-B are schematics showing an eighth exemplary embodiment of a display device according to the present invention.

As shown in the figure, in the display device according to this exemplary embodiment, the data signal processing circuit 4 includes a data line selection circuit 60, at least one data line control signal line 62 and a data line control circuit 61.

Here, the data line selection circuit 60 provides a respective specific data signal to each data signal line. The data line control circuit 61 provides the same data signal to all the data lines 2 by inputting a predetermined signal to the data line control signal line 62, irrespective of a data signal from the data line selection circuit 60.

Since the display device according to this exemplary embodiment has such structure, as shown in FIG. 8B, the same data signal is provided to all the data lines by inputting the predetermined signal (in the figure Hi signal) to the data line control signal line 62 irrespective of a data signal from the data line selection circuit 60 when the entire display region is erased. In this way, the same data signal (voltage) is provided to all the pixel electrodes and the display can be erased all at once throughout the display region.

Furthermore, since the above-described action, which is providing the same data signal (voltage) to all the data lines at the same time, is performed irrespective of the signal from the data line selection circuit 60, operation of the data line selection circuit 60 can be halted during the entire display region erasing action. This makes it possible to reduce the electric power consumption.

Moreover, when a new picture is written, a respective signal (voltage) can be provided to the pixel electrode coupled to each data signal line by providing the respective specific data signal to each data signal line from the data line selection circuit 60, without inputting a predetermined signal to the data line control signal line 62.

In FIG. 8B, the data signal is illustrated as a binary signal having only two values, Hi and Lo, by an example. It is not limited to the example and it may be a multivalued signal or an analog signal.

### Exemplary Embodiment 9

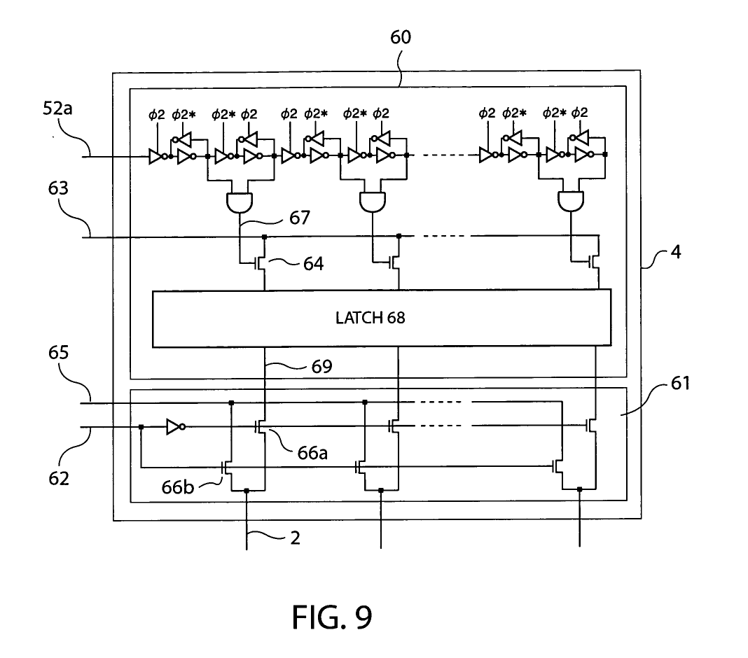

FIG. 9 shows a ninth exemplary embodiment of a display device according to the present invention.

As shown in the figure, in the display device according to this exemplary embodiment, the data signal processing circuit 4 includes the data line selection circuit 60, a data pulse input 52b, a data input 63, a common data input 65, the data line control signal line 62 and the data line control circuit 6 1. The data line selection circuit 60 includes the clocked-inverter type shift register whose input is the data pulse input 52b. A pulse signal input from the data pulse input 52b is sequentially sent synchronized with a clock Φ2 and a clock Φ2* (Φ2 and Φ2* are mutually reversed phase). The sent pulse signal becomes a data selection signal 67 to select a specific data signal line from a plurality of the data lines.

In addition, the data line selection circuit 60 includes an analog switch 64 that is provided in a plural number. Its gate signal is the data selection signal 67 and its input is the data input 63. The data line selection circuit 60 also includes a latch 68 whose input is an output of the analog switch. When one data signal line is selected by the data selection signal 67 at some moment, the analog switch 64 that corresponds to the selected data signal line is turned ON. At that point, a signal (voltage) that is provided in the data input 63 is sent to the latch 68 through the analog switch 64 and retained. In other words, if the respective data signal that is specific to each data signal line is provided to the data input 63 when that data signal line is selected, the specific data can be provided to only the intended data signal line. The respective specific data can be provided to the all the data signal lines by repeating such action as sequentially selecting the every data signal line.

The data line control circuit 61 consists of a plurality of pairs of an analog switch 66a and an analog switch 66b. An input of the analog switch 66a is an output 69 of the latch 68 and a gate signal of the analog switch 66a is an inversion signal of the data line control signal line 62. An input of the analog switch 66b is the common data input 65 and a gate signal of the analog switch 66b is the data line control signal line 62. The output of the analog switch 66a and the output of the analog switch 66b are coupled each other and also coupled to the corresponding data signal line. This pair of the analog switch 66a and the analog switch 66b works as a signal selector circuit whose one input is the output 69 of the latch 68, the other input is the common data input 65 and output is the data lines 2. The signal selector circuit selects any one of the inputs by the data line control signal line 62 and outputs.

At the time of the entire display region erasing, logical “Hi” is input to the data line control signal line 62, and at the same time signals (voltages) that are supposed to be provided to all the pixel electrodes is input to the common data input 65. At this time, since the analog switch 66a is off while the analog switch 66b turns ON, the signal (voltage) that is input to the common data input 65 is provided to all the data signal lines irrespective of the output 69 of the latch 68. And then, when all the switching elements turn ON in the same way as described above in the sixth or seventh exemplary embodiments, the same signal (voltage) is provided to all the pixel electrodes all at once and the display can be erased all at once throughout the display region.

On the other hand, when a new picture is written, logical “Lo” is input to the data line control signal line 62. Then, the analog switch 66b is turned OFF and the analog switch 66a is turned ON. Accordingly, the output 69 of the latch 68 is provided to the data signal line 2 without change and the respective specific data can be provided to each data signal line.

### Exemplary Embodiment 10

Exemplary embodiments of electronic equipment according to the present invention will be now described.

<Cellular Phone>

First, an exemplary embodiment of which the electronic equipment of the present invention is applied to a cellular phone is described.

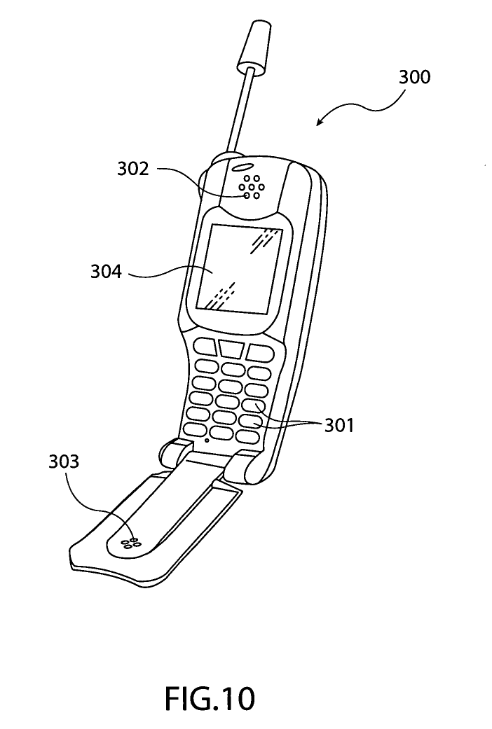

FIG. 10 is a schematic perspective view showing the exemplary embodiment of which the electronic equipment of the present invention is applied to the cellular phone. A cellular phone 300 shown in FIG. 10 includes a plurality of manual operation buttons 301, an ear piece 302, a mouth piece 303 and a display panel 304.

In such cellular phone 300, the display panel 304 is made of the above-described the display device 20.

<Digital Still Camera>

Next, an exemplary embodiment of which the electronic equipment of the present invention is applied to a digital still camera is described.

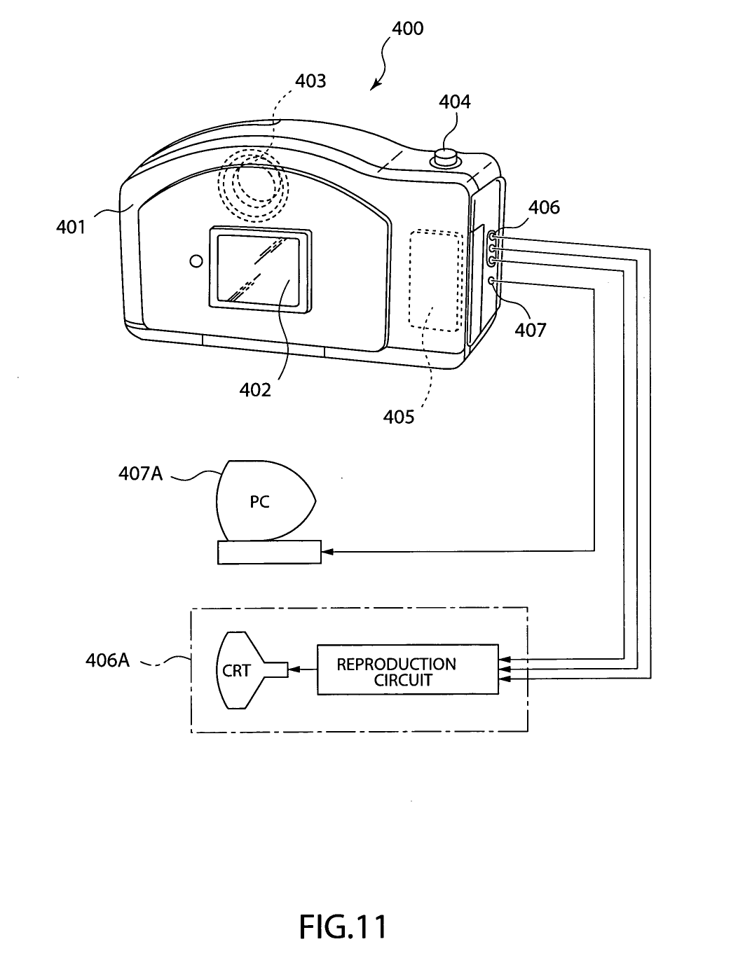

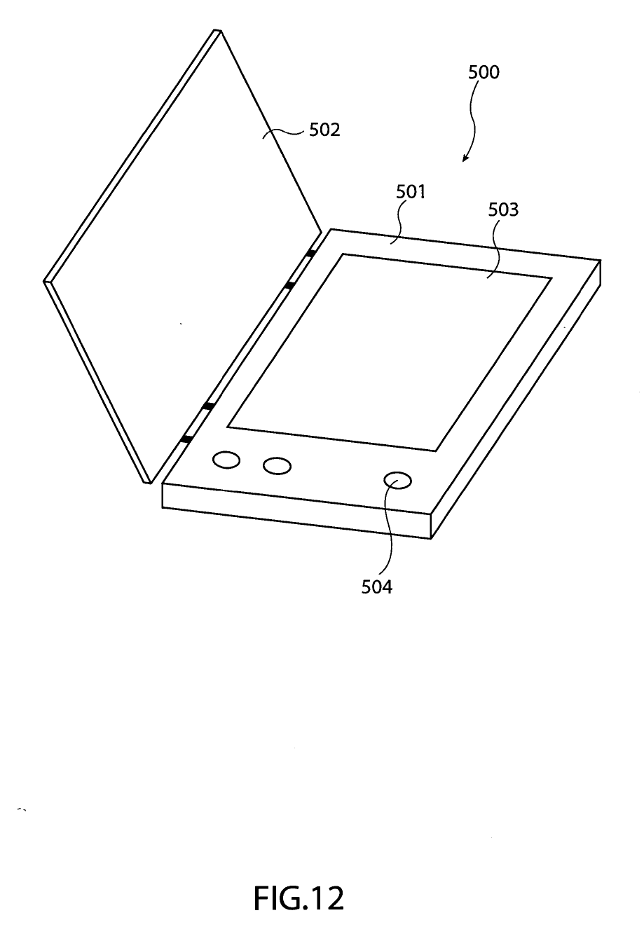

FIG. 11 is a schematic perspective view showing the exemplary embodiment of which the electronic equipment of the present invention is applied to the digital still camera. In FIG. 11, a back side of the page is called “front face”, and a near side of the page is called “back face”. Interfaces to external devices are also schematically shown in FIG. 11.

A digital still camera 400 shown in FIG. 11 includes a case 401, a display panel 402 formed behind the case 401, a photo acceptance unit 403 formed in a viewing screen side (in FIG. 11, the near side of the page) of the case 401, a shutter button 404 and a circuit board 405.

The photo acceptance unit 403 includes, for example, an optic lens, a charge couple device (CCD) and the like.

The display panel 402 display a picture based on an image signal from CCD.

The image signal of CCD at the time of pressing the shutter button 404 is transferred and stored in the circuit board 405.

Also, in the digital still camera 400 of this exemplary embodiment, a video signal output terminal 406 and an input-output terminal 407 for data communication are provided on a side surface of the case 401.

For example, a television monitor 406A is plugged in the video signal output terminal 406 and a personal computer 407A is plugged in the input-output terminal 407 as shown in the figure, according to need.

This digital still camera 400 is formed to output the image signal stored in the memory of the circuit board 405 to the television monitor 406A and the personal computer 407A with a predetermined operation.

In such digital still camera 400, the display panel 402 is made of the above-described the display device 20.

<Electronic Book>

Next, an exemplary embodiment of which the electronic equipment of the present invention is applied to an electronic book is described.

FIG. 12 is a schematic perspective view showing the exemplary embodiment of which the electronic equipment of the present invention is applied to the electronic book.

An electronic book 500 shown in FIG. 12 includes a book shaped frame 501 and a turnable (openable and closable) cover 502 for the frame 501. In the frame 501, a display device 503 is installed so as to expose its display surface and an operating member 504 is also installed.

In such electronic book 500, the display panel 503 is made of the above-described the display device 20.

<Electric Paper>

Next, an exemplary embodiment of which the electronic equipment of the present invention is applied to an electronic paper is described.

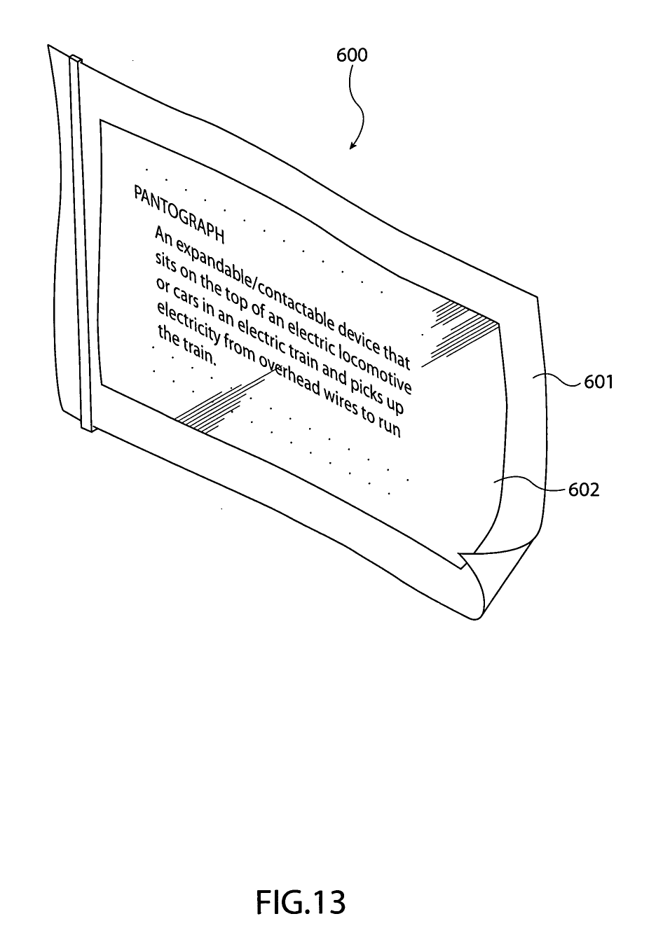

FIG. 13 is a schematic perspective view showing the exemplary embodiment of which the electronic equipment of the present invention is applied to the electronic paper.

An electronic paper 600 shown in FIG. 13 includes a main body 601 that consists of a rewritable sheet having the same texture and flexibility as that of paper and a display unit 602.

In such electronic paper 600, the display unit 602 is made of the above-described the display device 20.

<Electric Notebook>

Next, an exemplary embodiment of which the electronic equipment of the present invention is applied to an electronic notebook is described.

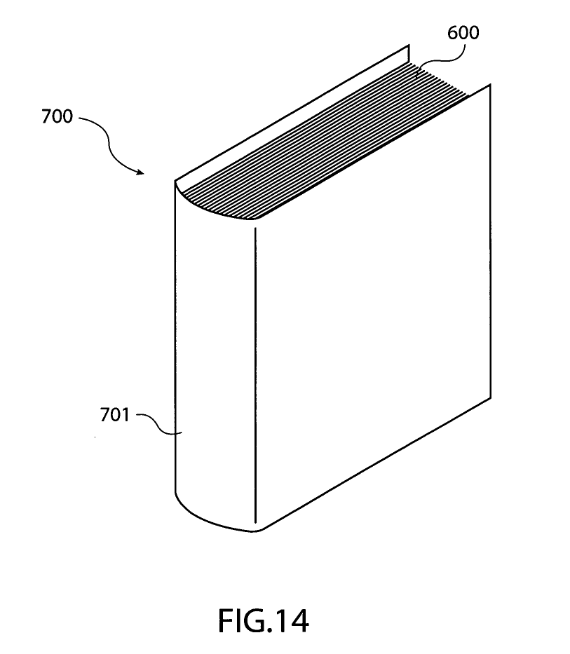

FIG. 14 is a schematic perspective view showing the exemplary embodiment of which the electronic equipment of the present invention is applied to the electronic notebook.

An electronic notebook 700 shown in FIG. 14 includes a cover 701 and the electronic paper 600.

The electronic paper 600 has the above-described structure or the same structure as one shown in FIG. 13. The electronic paper 600 is provided in a plural number and they are bundled together so as to be interposed in the cover 701.

An input device to input a display data is also provided in the cover 701. With this, display contents can be changed even though the electronic papers 600 are bundled.

In such electronic notebook 700, the electronic paper 600 is made of the above-described the display device 20.

<Display>

Next, an exemplary embodiment of which the electronic equipment of the present invention is applied to a display is described.

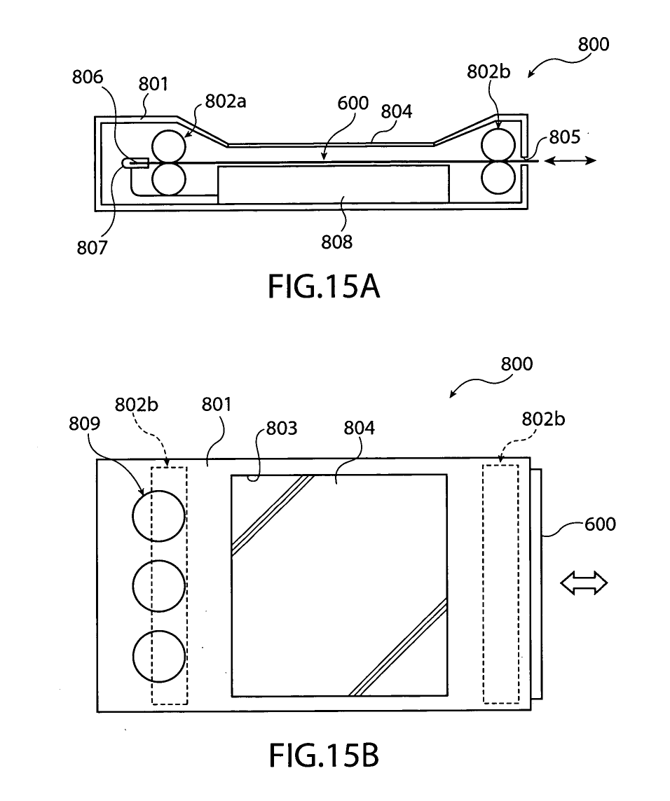

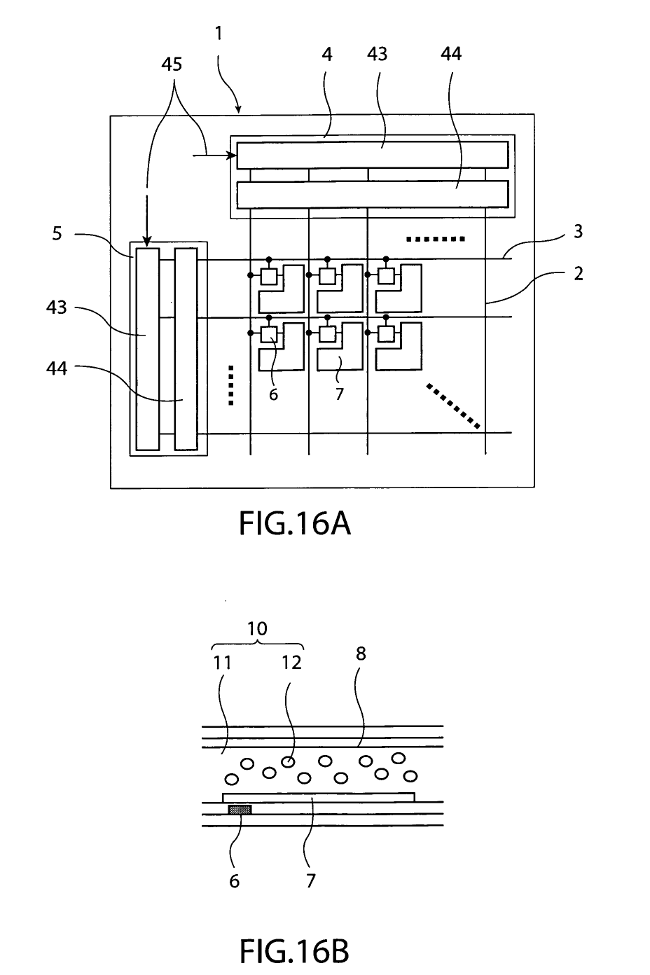

FIGS. 15A-B show the exemplary embodiment of which the electronic equipment of the present invention is applied to the display. FIG. 15A is a sectional view, and FIG. 15B is a schematic plan view.

A display (display device) 800 shown in FIGS. 15A-B includes a main body 801 and the electronic paper 600 that can be attached to the main body 801 and removed from it. The electronic paper 600 has the above-described structure or the same structure as one shown in FIG. 13.

An insertion slot 805 in which the electronic paper 600 can be inserted is formed on a side face (right side in FIGS. 15A-B) of the main body 801. Two pairs of carrier rollers 802a and 802b are also provided inside the main body 801. When the electronic paper 600 is inserted in the main body 801 through the insertion slot 805, the electronic paper 600 is interposed between the carrier rollers 802a and 802b and put into the main body 801.

A rectangular opening 803 is formed on a display side (the near side of the page in FIG. 15b) of the main body 801, and a transparent glass substrate 804 is embedded in the opening 803. With such structure, the electronic paper 600 that is put into the main body 801 is visible from the outside of the main body 801. In other words, the display 800 displays a picture by being seen the electronic paper 600 put into the main body 801 through the transparent glass substrate 804.

A terminal member 806 is provided on a fore-end of the electronic paper 600 in the insertion direction (left side in FIG. 15). A socket 807, to which the terminal member 806 is coupled as the electronic paper 600 is put into the main body 801, is provided inside the main body 801. A controller 808 and an operating part 809 are electrically coupled to the socket 807.

In such display, the electronic paper 600 is formed to be detachable from the main body 801, and it can be used as being detached from the main body, and then it can be took along with you.

Also, in such display 800, the electronic paper 600 is made of the above-described the display device 20.

The electric apparatus of exemplary embodiments of the present invention is not limited to be applied to the above-mentioned things. For example, television, a view finder type or direct view type video tape recorder, a car navigation device, a pager, an electronic databook, a calculator, an electronic newspaper, a word processor, a personal computer, a work station, a videophone, a point-of-sale terminal, equipments having a touch panel and the like, can be pointed. The display device 20 of exemplary embodiments of the present invention can be applied to the display parts of these pieces of electronic apparatus.

[Industrial Applicability]

With the display device according to exemplary embodiments of the present invention, when a picture is rewritten, especially the time of the entire display region erasing action and the electric power consumption can be dramatically reduced.

1. A display device, comprising:
a display material having optical characteristic changing in response to an electric stimulus;
a plurality of data signal lines;
a plurality of scanning signal lines intersecting the data signal lines;
a data signal processing circuit providing a data signal to the plurality of data signal lines and supplying a same data signal to all of the data signal lines at a same time, the data signal processing circuit supplying each specific data signal to each corresponding data signal line; and
a scanning signal processing circuit providing a scanning signal to the plurality of scanning signal lines and selecting all of the scanning signal lines at a same time, the optical characteristic of the display material being changed by controlling the data signal and the scanning signal.

2. The display device according to claim 1, the display material being an electrophoretic dispersion liquid including a liquid dispersion medium and electrophoretic particles.

3. The display device according to claim 2, the electrophoretic dispersion liquid being encapsulated in a microcapsule.

4. The display device according to claim 1, the scanning signal processing circuit further including a scanning line selection circuit to select a specific scanning signal line from a plurality of the scanning lines and at least one scanning line control signal line, the scanning signal processing circuit selecting all the scanning lines at a same time by inputting a predetermined signal to the scanning line control signal line irrespective of a signal from the scanning line selection circuit.

5. The display device according to claim 1, the data signal processing circuit further including a data line selection circuit supplying a respective specific data signal to each data signal line and at least one data line control signal line, the data signal processing circuit supplying a same data signal to all of the data lines at a same time by inputting a predetermined signal to the data line control signal line irrespective of a data signal from the data line selection circuit.

6. A driving method of a display device that includes an electrophoretic dispersion liquid including a liquid dispersion medium and electrophoretic particles, a plurality of data signal lines, a plurality of scanning signal lines intersecting the data signal line, a data signal processing circuit providing a data signal to the plurality of data signal lines and having a specific data signal supplying each specific data signal to each corresponding data signal line and a all data signal of supplying a same data signal to all the data signal lines at a same time and a scanning signal processing circuit providing a scanning signal to the plurality of the scanning signal lines and selecting a specific scanning line from the plurality of the scanning signal lines and selecting all the scanning signal lines at a same time, and in which the optical characteristic of the display material is changed by controlling the data signal and the scanning signal, the method comprising:
erasing an old picture throughout an entire display region by setting off the all data signal to send a same erasing data signal to all the data signal lines at a same time and setting off the all selecting signal when a picture of the display device is rewritten; and
writing a new picture by setting off the specific data signal and the specific selecting signal after erasing the old picture.

7. An electronic equipment, comprising:
the display device according to claim 1.
